(19) United States
(12) Patent Application Publication
(10) Pub. No.: US 2003/0134178 A1
(43) Pub. Date: Jul. 17, 2003

(54) Precompressed gas diffusion layers for electrochemical cells

(75) Inventor: James Michael Larson, Saint Paul, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 10/028,173

(22) Filed: Dec. 21, 2001

(51) Int. Cl. H01M 4/88; B05D 5/12; H01M 4/94

(52) U.S. Cl. 429/44; 429/30; 502/101; 427/115

(57) ABSTRACT

A method is provided for making a gas diffusion layer (GDL) for an electrochemical cell comprising the steps of coating a surface of a plain-weave carbon fiber cloth with a layer comprising carbon particles and one or more highly fluorinated polymers to make a coated plain-weave carbon fiber cloth, and compressing the coated plain-weave carbon fiber cloth to a compression of 25% or greater. Typically the GDL according to the present invention can be incorporated into a membrane electrode assembly (MEA) comprising a very thin polymer electrolyte membrane (PEM), typically having a thickness of 50 microns or less, without increased shorting across the PEM even when the MEA is under compression. A membrane electrode assembly (MEA) is also provided comprising a gas diffusion layer that comprises a plain-weave carbon fiber cloth, and comprising a polymer electrolyte membrane (PEM) having a thickness of 50 microns or less, where the membrane electrode assembly (MEA) has an electrical area resistance of 400 ohm*cm² or greater when compressed to 25% compression.

This invention was made with Government support under Cooperative Agreement DE-FC02-99EE50582 awarded by DOE. The Government has certain rights in this invention.

### FIELD OF THE INVENTION

This invention relates to a plain-weave carbon fiber cloth gas diffusion layer (GDL) for an electrochemical cell which can be incorporated into a membrane electrode assembly (MEA) comprising a very thin polymer electrolyte membrane (PEM) without increased shorting across the PEM even when the MEA is under compression.

### BACKGROUND OF THE INVENTION

U.S. Pat. No. 6,127,059 describes the use of a coated gas diffusion layer in an electrochemical cell.

### SUMMARY OF THE INVENTION

Briefly, the present invention provides a method of making a gas diffusion layer (GDL) for an electrochemical cell comprising the steps of coating a surface of a plain-weave carbon fiber cloth with a layer comprising carbon particles and one or more highly fluorinated polymers to make a coated plain-weave carbon fiber cloth, and compressing the coated plain-weave carbon fiber cloth to a compression of 25% or greater. Typically the GDL according to the present invention can be incorporated into a membrane electrode assembly (MEA) comprising a very thin polymer electrolyte membrane (PEM), typically having a thickness of 50 microns or less, without increased shorting across the PEM even when the MEA is under compression.

In another aspect, the present invention provides a membrane electrode assembly (MEA) comprising a gas diffusion layer that comprises a plain-weave carbon fiber cloth, and comprising a polymer electrolyte membrane (PEM) having a thickness of 50 microns or less, where the membrane electrode assembly (MEA) has an electrical area resistance of 400 ohm*cm² or greater when compressed to 25% compression.

What has not been described in the art, and is provided by the present invention, is a plain-weave carbon fiber cloth gas diffusion layer (GDL) for use in an electrochemical cell which can be used with a very thin polymer electrolyte membrane (PEM) without increased shorting across the PEM even when the MEA is under compression.

In this application:

“X % compression” means compression to a thickness X % less than uncompressed thickness;

“vehicle” means a fluid which carries the particulate in a dispersion, which typically includes water or an alcohol;

“highly fluorinated” means containing fluorine in an amount of 40 wt % or more, but typically 50 wt % or more, and more typically 60 wt % or more;

“high shear mixing” means a mixing process wherein the fluid to be mixed encounters zones of shear having a shear rate greater than 200 sec⁻¹ ¹, and more typically greater than 1,000 sec⁻¹, typified by mixing with a high speed disk disperser or Cowles blade at sufficient rpms;

“ultra high shear mixing” means a mixing process wherein the fluid to be mixed encounters zones of shear having a shear rate greater than 10,000 sec⁻¹, and more typically greater than 20,000 sec⁻¹, typified by bead milling or sand milling at sufficient rpms;

“low shear mixing” means a mixing process wherein the fluid to be mixed does not substantially encounter zones of shear having a shear rate greater than 200 sec⁻¹, more typically not greater than 100 sec⁻¹, more typically not greater than 50 sec⁻¹, and more typically not greater than 10 sec⁻¹, typified by paddle mixing, hand stirring, or low-rpm mixing with a high speed disk disperser;

“low shear coating” means a coating process wherein the fluid to be coated does not substantially encounter zones of shear having a shear rate greater than 2000 sec⁻¹, more typically not greater than 1000 sec⁻¹, more typically not greater than 500 sec⁻¹, and more typically not greater than 100 sec⁻¹, typified by three-roll coating;

“carbon bleed-through” refers to the presence of carbon particles on an uncoated side of an electrically conductive porous substrate which have migrated through the substrate from a coated side, typically in an amount sufficient to be visible to the naked eye or more; and

“substituted” means, for a chemical species, substituted by conventional substituents which do not interfere with the desired product or process, e.g., substituents can be alkyl, alkoxy, aryl, phenyl, halo (F, Cl, Br, I), cyano, nitro, etc.

It is an advantage of the present invention to provide a plain-weave carbon fiber cloth gas diffusion layer (GDL) for an electrochemical cell which can be incorporated into a membrane electrode assembly (MEA) comprising a very thin polymer electrolyte membrane (PEM) without increased shorting across the PEM even when the MEA is under compression.

### DETAILED DESCRIPTION OF PREFERRED EMBODIMENTS

Briefly, the present invention provides a method of making a gas diffusion layer (GDL) for an electrochemical cell comprising the steps of coating a surface of a plain-weave carbon fiber cloth with a layer comprising carbon particles and one or more highly fluorinated polymers to make a coated plain-weave carbon fiber cloth, and compressing the coated plain-weave carbon fiber cloth to a compression of 25% or greater.

Fuel cells are electrochemical cells which produce usable electricity by the catalyzed combination of a fuel such as hydrogen and an oxidant such as oxygen. Typical fuel cells contain layers known as gas diffusion layers (GDL) or diffuser/current collector layers (DCC) adjacent to catalytically reactive sites. These layers must be electrically conductive yet must be able to allow the passage of reactant and product fluids. Typical gas diffusion layers are coated with a layer of carbon particles and fluoropolymers on the surface adjacent to the catalyst. The catalytically reactive sites are thin layers of catalyst dispersion on either side of a polymer electrolyte membrane (PEM). While use of a thin PEM can increase efficiency, it can also increase the risk of PEM puncture. This invention concerns a plain-weave carbon fiber cloth gas diffusion layer (GDL) for an electrochemical cell which can be incorporated into a membrane electrode assembly (MEA) comprising a very thin polymer electrolyte membrane (PEM) without increased shorting across the PEM even when the MEA is under compression.

The GDL may be comprised of any suitable plain-weave carbon cloth. Carbon clothes which may be useful in the practice of the present invention may include: Avcarb™ 1071 HCB (“HCB”) and Avcarb™ 1071 CCB (“CCB”) (Textron, now Ballard Material Products), Panex™ PWO3 carbon cloth (“PWO3”)(Zoltek), and the like. The carbon cloth may be treated prior to coating. Typical treatments include those that increase or impart hydrophobic properties, such as treatment with fluoropolymers such as PTFE. Other typical treatments may increase or impart hydrophilic properties.

Before pre-compression, the plain-weave carbon fiber cloth is coated with a coating composition comprising carbon particles and one or more highly fluorinated polymers in a vehicle. Typically the plain-weave carbon fiber cloth is coated on one side only, the side which will face the catalyst layer of the MEA.

The coating composition may employ any suitable aqueous vehicle. The vehicle comprises water and may additionally comprise alcohols, and more typically comprises only water or alcohols. Most typically the vehicle comprises water alone.

The coating composition may comprise any suitable surfactant or dispersant, including amine oxide surfactants described in co-pending patent application ______. Suitable amine oxides may belong to formula II: R₃N→O, where each R is independently selected from alkyl groups containing 1-20 carbons, which optionally include ether and alcohol groups, and which may be additionally substituted. Typical amine oxide surfactants according to the cited disclosure are alkyl dimethylamine oxides according to formula (1):

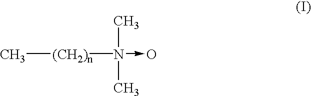

wherein n is 9 to 19 or more typically 11 to 15. Most typically, n is 11 or 13. The amine oxide according to formula (I) is optionally substituted. Suitable amine oxide surfactants may include those available under the trade names Genaminox®, Admox®, Ammonyx®, and Ninox®.

Other suitable surfactants may include alcohol alkoxylates such as Triton™ x100.

The coating composition typically comprises 0.1-15% surfactant by weight, more typically 0.1-10% by weight, and most typically 1-5% by weight.

Any suitable carbon particles may be used. It will be understood that the term “carbon particles” as used herein can refer to primary particles, typically having a average size of 1-100 nm, primary aggregates of primary particles, typically having an average size of 0.01-1 microns, secondary aggregates of primary aggregates, typically having an average size of 0.1-10 microns, and agglomerates of aggregates, typically having an average size of greater than 10 micron. Most typically, the term “carbon particles” refers to primary particles or primary aggregates. Typically a carbon black is used, such as Vulcan XC-72 (Cabot Corp., Special Blacks Division, Billerica, Mass.), Shawinigan Black, grade C55, (Chevron Phillips Chemical Company, LP, Acetylene Black Unit, Baytown, Tex.) or Ketjenblack EC300J (Akzo Nobel Chemicals Inc., Chicago, Ill.). Graphite particles may also be used, but typically have larger particle sizes. The aqueous coating composition typically comprises 1-50% carbon particles by weight, more typically 1-20% by weight, and most typically 5-15% by weight. Typically, the aqueous coating composition comprises lower weight percent content of carbon particles where smaller particles are used. The highest weight percent content of carbon particles are achieved with the addition of graphite particles, which typically have larger particle sizes.

The carbon particles are typically suspended in the vehicle by high shear mixing to form a preliminary composition. High shear mixing advantageously provides improved wetting-out of carbon particles with the vehicle as well as improved dispersion and de-agglomeration. In addition, the preliminary composition may be degassed or defoamed by any suitable method, including standing. The preliminary composition may be further mixed by ultra high shear mixing, typically after degassing or defoaming.

A thickening agent may be added to the preliminary composition. Any suitable thickening agent may be used, including polyacrylates such as Carbopol® EZ-2 (B. F. Goodrich Specialty Chemicals, Cleveland, Ohio).

A defoaming agent may be added to the preliminary composition. Any suitable defoaming agent may be used, such as Mazu® DF 210 SX (BASF Corp., Mount Olive, N.J.).

Any suitable highly fluorinated polymers may be used. The highly fluorinated polymer is typically a perfluorinated polymer, such as polytetrafluoroethylene (PTFE), fluorinated ethylene propylene (FEP), perfluoroalkyl acrylates, hexafluoropropylene copolymers, tetrafluoroethylene/hexafluoropropylene/vinylidene fluoride terpolymers, and the like. The aqueous coating composition typically comprises 0.1-15% highly fluorinated polymers by weight, more typically 0.1-10% by weight, and most typically 1-5% by weight. The highly fluorinated polymer is typically provided as an aqueous or alcoholic dispersion, most typically aqueous, but may also be provided as a powder.

Any suitable method of coating may be used. Typical methods include both hand and machine methods, including hand brushing, notch bar coating, wire-wound rod coating, fluid bearing coating, slot-fed knife coating, and three-roll coating. Most typically three-roll coating is used. Advantageously, coating is accomplished without carbon bleed-through from the coated side of the substrate to the uncoated side. Coating may be achieved in one pass or in multiple passes. Coating in multiple passes may be useful to increase coating weight without corresponding increases in mud cracking.

The coated substrate may then be heated to a temperature sufficient to remove the vehicle and surfactants. The coated substrate may be heated to a temperature sufficient to sinter the highly fluorinated polymers.

The resulting coated plain-weave carbon fiber cloth is then compressed by any suitable method to a compression of 25% or greater, more typically 28% or greater, more typically 40% or greater, and most typically 50% or greater. However, compression of 60% or greater may damage the structural integrity of the cloth. This compression step is accomplished without attaching the coating plain-weave carbon fiber cloth to another layer. Compression may be accomplished by any suitable method, including platen pressing and, more typically, calendering.

The resulting gas diffusion layer is typically incorporated into a membrane electrode assembly for use in an electrochemical cell such as a hydrogen fuel cell by any suitable method. Typically, a polymer electrolyte membrane (PEM) is coated on one or, more typically, both sides with a dispersion of platinum-containing catalyst. The PEM may be composed of any suitable polymer electrolyte material. Typically the PEM is composed of acid-functional fluoropolymers or salts thereof, such as Nafion® (DuPont Chemicals, Wilmington Del.) and Flemion™ (Asahi Glass Co. Ltd., Tokyo, Japan). The polymer electrolyte of the PEM is typically a copolymers of tetrafluoroethylene and one or more fluorinated, acid-functional comonomers, typically bearing sulfonate functional groups. Most typically the polymer electrolyte is Nafion™. The polymer electrolyte preferably has an acid equivalent weight of 1200 or less, more preferably 1100 or less, more preferably 1050 or less, and most preferably about 1000. The GDL according to the present invention can be advantageously used with very thin PEM layers, typically 50 microns or less in thickness, more typically 35 microns or less in thickness, and most typically 25 microns or less in thickness. Typically the PEM is laminated with a GDL on each side by application of heat and pressure. Alternately, the dispersion of platinum-containing catalyst may be applied to each GDL prior to lamination rather than to each side of the PEM.

MEA's according to the present invention advantageously demonstrate improved resistance to electrical shorting under pressure. For purposes of the Examples below, a short is defined as a measured electrical resistance of less than 200 ohms for an MEA of 20 cm² area, or a electrical area resistance of 4000 ohm*cm². However, electrical area resistance levels down to 1000 ohm*cm² or even 400 ohm*cm² are acceptable in practice as “non-shorting”. The MEA according to the present invention typically can be made with a thin PEM of 50 microns thickness or less yet will not short at a compression of 20% or more, more typically 25% or more, more typically 35% or more, and more typically 40% or more. More typically, the MEA according to the present invention can be made with a thin PEM of 35 microns thickness or less yet will not short at a compression of 20% or more, more typically 25% or more, more typically 35% or more, and more typically 40% or more.

In addition, the Examples illustrate that Gurley number of the GDL may be manipulated according to the present invention, with or without manipulation of shorting reduction properties. In one application, the Gurley number may be increased without increasing coating thickness on the GDL.

This invention is useful in the manufacture of a gas diffusion layer for use in electrochemical cells such as hydrogen fuel cells.

Objects and advantages of this invention are further illustrated by the following examples, but the particular materials and amounts thereof recited in these examples, as well as other conditions and details, should not be construed to unduly limit this invention.

### Examples

Unless otherwise noted, all reagents were obtained or are available from Aldrich Chemical Co., Milwaukee, Wis., or may be synthesized by known methods.

Membrane Electrode Assembly (MEA) Manufacture

MEA's were made as follows:

GDL Manufacture: The plain weave carbon cloth was selected from Avcarb™ 1071 HCB (“HCB”) and Avcarb™ 1071 CCB (“CCB”) (Textron, now Ballard Material Products) and Panex™ PWO3 carbon cloth (“PWO3”)(Zoltek) as indicated for each Example in the tables below. The cloth was first dip coated in PTFE using a 1.0 wt. % solution of Dyneon TF 5235 PTFE Dispersion (60% PTFE by weight as sold, herein diluted with DI water)(Dyneon LLC, Aston, Pa.), air dried, and then coated with the dispersion indicated in each Example in the tables below. The dispersion was coated onto the carbon cloth by a three roll coating method using a Hirano Tecseed M200LC coater. This three-roll coating method is commonly referred to as a three roll nip-fed reverse roll coater. (See, Coyle, D. J., Chapter 12 “Knife and roll coating” in Liquid Film Coating, ed. Stephan F. Kistler and Peter M. Schweizer, Chapman & Hall, The University Press, Cambridge, 1997, incorporated herein by reference.) The coated cloth was then sintered at 380° C. for 10 min. 50 cm² samples were die cut from this for use in MEA manufacture.

The coating dispersions were made as follows:

Dispersion XC-72: 19.20 kg of carbon black Vulcan XC-72 (Cabot Corp., Special Blacks Division, Billerica, Mass.), was added rapidly to 123.6 kg of deionized water in a plastic-lined 208 L drum while mixing with a 22.9 cm diameter high-speed disk disperser (HSDD). The HSDD rpm was increased gradually as the apparent viscosity increased. When the mixture reached the point that the HSDD was no longer able to move the mixture and/or when ridges were noted on the surface, surfactant Genaminox CST (Clariant Corporation, Functional Chemicals, Mt. Holly, N.C.) (30% surfactant by weight in water) was added in 1 L increments until the mixture could be moved by the HSDD again, and then the remainder of a total of 16.9 kg additional Genaminox CST was added incrementally. After standing overnight to allow foam to collapse, a 15.2 cm diameter, 3 blade propeller mixer at low rpm, only high enough to just move the mixture) was used to re-suspend any carbon that had settled and then, for ultra high shear mixing, the mixture was pumped through a 13 L horizontal media mill having a 50 vol. % charge of 0.8-1.9 mm type SEPR ceramic media at 0.95 L/minute and a shaft rotation of 1200 rpm. The discharged dispersion did not contain any significant amount of foam. It was stored in 19 L plastic containers.

Particle size analysis of the resulting preliminary composition was done using a Horiba LA-910 particle size analyzer (Horiba Instruments Inc., Irvine, Calif.). On a number basis, the mean particle size was 0.354 micron, 10% were larger than 0.548 micron, and 90% were larger than 0.183 micron. Only 0.20% was larger than 1.000 micron.

A coating composition was prepared by adding 813.5 g of Dyneon TF 5235 PTFE Dispersion (60% PTFE by weight)(Dyneon LLC, Aston, Pa.) to 16.229 kg of the above dispersion to provide an 80/20 w/w ratio of carbon to PTFE. Simple low shear hand mixing with a spatula was sufficient for mixing.

Dispersion TXC-72: 13.2 g of Carbopol EZ-2 (B. F. Goodrich) were sifted into 13.000 kg of the preliminary composition of XC-72 while mixing at 1000 rpm with a 8.9 cm diameter high-speed disk disperser (HSDD). (Model HAS40A 4hp air mixer with 11.4 cm (4.5″) diameter Cowles Blade, INDCO Inc.)

A coating composition was prepared by adding 9.25 g of ammonium hydroxide to 601.5 g of Dyneon 5235 PTFE and adding this mixture to the Carbopol EZ-2 containing carbon dispersion while continuing to mix until the mixer could no longer move the mixture at 1000 rpm to thicken the dispersion. Note that the amount of ammonium hydroxide used was sufficient to completely neutralized the EZ-2 acidic functional groups. Then 0.20 g of Mazu® DF 210 SX (BASF Corp., Mount Olive, N.J.) was added to facilitate defoaming.

Dispersion C55: To 5482 g of deionized water in a 7.6 L stainless steel metal beaker (23 cm diameter) were added 389 g of Shawinigan Black, grade C55 (Chevron Phillips Chemical Company, LP, Acetylene Black Unit, Baytown, Tex.) and 687 g of Genaminox CST through use of alternating additions of increments of the total amounts of carbon black and surfactant while mixing with a 7.6 cm diameter high-speed disk disperser (HSDD) blade (Model ASSAM 0.5 hp air mixer, equipped with a 7.6 cm (3″) diameter Design A Cowles Blade, INDCO Inc.), together with an air driven rotor-stator (RS) mixer having a rotor with a diameter of approximately 2.5 cm (1″). The initial HSDD rpm was about 1000 and the RS mixer was used at the lower end of its speed range during additions. The HSDD rpm was increased gradually during additions to about 1800 rpm. After additions were completed, the rpm for the RS mixer was increased to close to the maximum and mixing with both mixers was continued for 2 hours at these high shear conditions. Over this time, the HSDD rpm were decreased to about 1600 rpm as the apparent viscosity decreased. Upon standing overnight, most of the foam broke and remaining coarse foam broke quickly when stirred with a spatula.

Analysis of the particle size of the resultant dispersion on a particle number basis gave a mean particle diameter of 0.317 micron, 10% greater than 0.555 micron, 90% greater than 0.138 micron, and only 1.4% greater than 1.000 micron.

An additional batch of the above dispersion was prepared by the same method. The combined mass of the two batches was 11,449 g. Then 305.3 g of Dyneon 5235 PTFE dispersion was added by mixing by hand with a spatula having a 45 cm wide blade.

Dispersion EC300J: This dispersion was prepared using the same mixers as for C55. To 5000 g of deionized water in a 7.6 L stainless steel metal beaker (23 cm diameter) were added 352 g of Ketjenblack EC300J (Akzo Nobel Chemicals Inc., Chicago, Ill.). All the EC300J was added to the water starting with the HSDD at 100 rpm and the RS at low rpm. Then 1049 g of Genaminox CST was added incrementally with sufficient time between additions for the apparent viscosity to increase to a point close to where the HSDD could no longer move the mixture. The initial HSDD rpm was about 1000 and the air driven RS mixer was used at the lower end of its speed range during additions. The HSDD rpm was gradually increased to 1500 rpm during addition of the EC300J. After additions were completed, the HSDD rpm was increased to about 1700 and the rpm for the RS mixer was increased to close to the maximum. Mixing with both mixers was continued for 2 hours at these high shear conditions. Upon standing overnight, most of the foam broke and remaining coarse foam broke quickly when stirred with a spatula.

Analysis of the particle size of the resultant dispersion on a particle number basis gave a mean particle diameter of 0.317 micron, 10% greater than 0.555 micron, 90% greater than 0.138 micron, and only 1.4% greater than 1.000 micron, and 1.9% greater than 1.000 micron.

An additional batch of the above dispersion was prepared by the same method. The combined mass of the two batches was 10,759 g. Then 269.5 g of Dyneon 5235 PTFE dispersion was added by mixing by hand with a spatula having a 45 cm wide blade.

ELA™ GDLs: Examples were run demonstrating pre-compression of commercially available coated GDL's: SS ELAT™ (single-sided coating) and DS ELAT™ (double-sided coating) (E-tek, Division of De Nora North America). The SS ELAT™ was found to have a Critical % Compression for PEM Puncture of 9% as purchased, which increased to 26% after pre-compression using the press method described below. The DS ELAT™ was found to have a Critical % Compression for PEM Puncture of 20% as purchased, which increased to 29% after pre-compression using the press method described below.

GDL Precompression: Precompression was accomplished by calendering or pressing.

GDL Calendering: The coated GDL was calendered using a fixed gap calender, wherein the calendering apparatus supplies such force as is necessary to maintain a set gap width. The calendering rolls were 25.4 cm diameter steel rolls with a hardened chrome finish. Calendaring was performed at the speed, temperature and gap width indicated in the tables below.

GDL Pressing: The coated GDL was pressed by sandwiching the sample between two sheets of 50 micron thick polyimide film, and placing the sandwiched sample between the platens of a Carver Press (Fred Carver Co., Wabash, Ind.) for minute at a pressure of 91 kg/cm² and a temperature of 132° C. Closure of the press was limited by Teflon™-coated glass fiber gaskets to limit the compression to 40%.

Polymer Electrolyte Membrane: A polymer electrolyte membrane (PEM) was prepared by notch-coating an aqueous dispersion of Nafion™ 1000 (DuPont Chemical Co.) onto a backing of poly(vinyl chloride)-primed poly(ethylene terephthalate) (3M Co., St. Paul, Minn.) at a loading such that the final, dried film was approximately 30.5 m thick. The cast film was first passed through a drying oven at 50-60° C. (approximately 3-4 minutes dwell time), then dried at 130° C. for 4 minutes in an air-impingement oven to remove the remainder of the solvent and to anneal the Nafion™ film. The dried film was peeled from the backing for subsequent use.

Catalyst-Bearing PEM: Nanostructured platinum catalyst was impressed into the PEM as described in U.S. Pat. No. 5,879,828, incorporated herein by reference.

Five-Layer Membrane Electrode Assembly: The coated GDL's and catalyst-bearing PEM were laminated to form MEA's as follows. The PEM was sandwiched between two GDL's, with the coated side of the GDL facing the PEM. A gasket of Teflon™-coated glass fiber was also placed on each side. The GDL's were smaller in surface area than the PEM so that each fit in the window of the respective gasket. The height of the gasket was 70% of the height of the GDL, to allow 30% compression of the GDL when the entire assembly was pressed. The assembly was pressed in a Carver Press (Fred Carver Co., Wabash, Ind.) for 10 minutes at a pressure of 30 kg/cm² and a temperature of 130° C. to form the finished membrane electrode assembly (MEA).

MEA for Puncture Test: The MEA's used in puncture testing contained no catalyst, and therefore, it is believed that these test MEA's provided a more rigorous test.

Physical Property Measurements

Caliper: All caliper measurements were made using a gauge from TMI (Testing Machines Inc.), model 49-701-01-0001, that had a circular foot of 1.59 cm diameter and that closed with a pressure of 55.2 kPa.

Gurley Number: Gurley numbers were determined using a densometer from Gurley Precision Instruments, Model 4110, using an aperture of 0.90 cm on the open side and a cylinder weighing 142 g. The measurement merely involves clamping the sample in the instrument and allowing the cylinder to drop. The time taken for the cylinder to push a given number of cc of air through the sample is determined. All results given are for the time taken to pass 300 cc of air. See ASTM D726-58, Method A.

Basis Weight: Basis weight in g per square meter was determined by cutting samples using a metal die of either 25.4 mm or 47 mm diameter and determining the mass using an analytical balance with +/−0.1 mg precision capability.

Z-Axis electrical area resistance: electrical area resistance (in ohm*cm²) was tested using a Resistance/Compression Tester, comprising a press equipped to compress a sample between two electrically isolated platens so as to allow simultaneous measurement of compression and electrical resistance at a given pressure. All aspects of the device were computer controlled. A load cell was used to measure the force required to bring the plates together. In a preliminary portion of the test, the plate stopped when a given set pressure (345 kPa) was reached. The compressive modulus of the material was determined from this initial data and from the caliper of the sample before compression amount by which the sample had been compressed and corrected subsequent data at higher compressions for the amount of compression that had already occurred. This procedure allowed the instrument to determine what the separation between plates was before beginning compression. Also, it established sufficient electrical contact that a current could be applied and the voltage drop measured. The circuitry could not be turned on before this point. After this initial procedure, the bottom plate continued to advance towards the upper plate until the maximum pressure of the device, about 13,800 kPa was reached. The results of such an experiment included resistance in ohm and pressure in psi as a function of % compression. These data were then plotted and the % compression at which there was either a rapid drop or a general decline to 200 ohm was taken as the threshold for shorting.

% Compression for Shorting through PEM: The % compression required to create an electrical short through a perfluorosulfonic acid proton exchange membrane (cast Nafion™ 1000) of about 30.5 microns thickness was determined by the above method with the difference that the change in resistance in going from an insulator to a short could be determined with a standard ohm meter and the applied current/voltage drop method was not appropriate. Circular samples of MEA having an area of approximately 20 cm² were cut and used in these tests. A short was defined as having occurred when the resistance for the given size sample dropped below 200 ohm and the % compression at which this occurred was taken as the compression limit for avoidance of shorting.

Fuel Cell Polarization Experiments: Test stations manufactured by Fuel Cell Technologies (Albuquerque, N. Mex.) were used. Operation of the station was controlled by a computer and software developed by the 3M Co. Single cells having an active area of 50 cm² were used. The flow fields were a quad-serpentine design that was machined into graphite blocks. The test cells and the flow field graphite blocks were also obtained from Fuel Cell Technologies. The cell compression was controlled by gaskets. The gasket thickness was selected so as to compress the DCCs by about 30% based on the thickness of the DCCs before they were pre-compressed by the methods indicated unless noted otherwise.

Open Circuit Voltage: The open circuit voltage was determined after the cell had been thoroughly conditioned by observing the voltage indicated by the load box for the test station with the cathode high current lead disconnected so that there was no flow of current. While there are many factors that determine the OCV and that can cause its value to decrease, electrical shorts are one cause. If shorts are present, voltage will continue to decline with time due to degradation of the PEM around the short due to resistive heating generated by the short. Once holes are formed, OCV and voltage in general can decrease precipitously due to direct intermixing of hydrogen and oxygen, which is typically referred to as cross-over. At this point the cell is defective and no longer suitable for efficient or safe generation of electricity. The amount of cross over as well as the area resistance of the cell in ohm*cm² can be determined from standard electrochemical measurements on the cell at any point during an experimental evaluation. An increase in the amount of cross over with time may allow for distinction between holes that may have been present initially in the PEM versus those that developed over time as a result of shorts. Similarly, a decrease in resistance with time would be consistent with protrusions gradually working their way through the PEM.

The Tables below report the results of numerous Examples. For all of the Examples of Table II, the cloth was HCB and the dispersion was XC-72.

TABLE I

| | | | | | | | | Critical % Compression | | | | | | |
|---|---|---|---|---|---|---|---|---|---|---|---|---|---|---|
| | | | | | | | | for PEM | | | | | Gurley | |
| | | | Total | Calender Conditions | | | | Puncture | | | Caliper, microns | | (units per method given) | |
| | | Dis- | Basis | | | | % Pre- | No Pre- | | Calen- | Before | After | | |
| Ex. | | persion | Weight | Temp., | Speed | gap, | Com- | Com- | Press | der | Calen- | Calder- | Before | After |
| No. | Cloth | Type | g/m² | ° C. | ms⁻² | microns | pression | pression | Method | Method | dering | ing | Calendering | Calendering |
| 1 | HCB | XC-72 | 136 | 21 | 0.010 | 152 | 52 | 26(0) | 34(6) | 34(6) | 318(3) | 302(3) | 18(4) | 19(3) |
| 2 | HCB | XC-72 | 136 | 21 | 0.031 | 152 | 52 | | | 26(5) | 318(3) | 300(5) | 12(2) | 29(7) |
| 3 | HCB | XC-72 | 136 | 21 | 0.051 | 152 | 52 | | | 30(7) | 318(3) | 297(5) | 12(2) | 25(5) |
| 4 | HCB | XC-72 | 152* | 21 | 0.010 | 152 | 54 | 19(3) | 40(5) | 24(7) | 333(3) | 323(3) | 43(10) | 100(40) |
| 5 | HCB | TXC-72 | 146 | 21 | 0.010 | 178 | 50 | 20(11) | 37(5) | 40(2) | 356(5) | 356(3) | 8(3) | 12 (2) |
| 6 | HCB | C55 | 130 | | | | | 16(4) | 29(7) | | 328(3) | | | |
| 7 | HCB | C55 | 130 | 21 | 0.031 | 152 | 53 | | | 27(11) | 325(3) | 323(3) | 37(15) | 120(25) |
| 8 | HCB | C55 | 130 | 99 | 0.051 | 152 | 53 | | | 20(9) | 325(3) | 297(5) | 37(15) | 520(150) |
| 9 | HCB | C55 | 130 | 99 | 0.051 | 229 | 53 | | | 32(5) | 325(3) | 328(3) | 37(15) | 58(4) |
| 10 | HCB | EC300J | 130 | | | | | 21(13) | 24(12) | | 340(5) | | 6(2) | |
| 11 | PWO3 | XC-72 | 150 | 21 | 0.0025 | 178 | 52 | 27(3) | 39(3) | 33(5) | 376(13) | 351(8) | 18(4) | 45(11) |
| 12 | PWO3 | XC-72 | 150 | 21 | 0.010 | 178 | 52 | | | 30(9) | 376(13) | 366(8) | 18(4) | 42(9) |
| 13 | PWO3 | XC-72 | 150 | 21 | 0.020 | 178 | 52 | | | 36(4) | 376(13) | 356(5) | 18(4) | 44(9) |
| 14 | PWO3 | XC-72 | 150 | 21 | 0.046 | 178 | 52 | | | 29(1) | 376(13) | 353(8) | 18(4) | 39(9) |
| 15 | PWO3 | TXC-72 | 165 | 21 | 0.010 | 203 | 50 | 27(22) | 32(10) | 23(3) | 401(10) | 394(13) | 12(1) | 13(3) |
| 16 | PWO3 | C55 | 140 | 21 | 0.010 | 178 | 50 | 20(11) | 32(5) | 35(4) | 356(8) | 340(8) | 24(9) | 53(33) |
| 17 | PWO3 | EC300J | 146 | 21 | 0.010 | 178 | 51 | 14(4) | 28(12) | 24(8) | 363(8) | 371(8) | 7(2) | 12(1) |

*two coating passes

TABLE II

| | Calender Conditions | | | | | Caliper, microns | | Gurley | |
|---|---|---|---|---|---|---|---|---|---|
| Ex. | Temp., | | % Pre- | Speed | CPCPP after Calendering | Before | After | Before | After |
| No. | ° C. | gap | Compression | ms⁻² | (standard deviation) | Calendering | Calendering | Calendering | Calendering |
| 18 | 82 | 178 | 44 | 0.051 | 41(13), one value>50 | 312(3) | 305(3) | 12(2) | 46(8) |
| 19 | 116 | 152 | 56 | 0.010 | 39(18),two values>50 | 345(5) | 325(3) | 8(1) | 62(10) |
| 20 | 116 | 152 | 56 | 0.051 | 24(9) | 345(3) | 320(5) | 8(1) | 48(6) |
| 21 | 116 | 152 | 56 | 0.102 | 47(5),two values>50 | 345(3) | 325(3) | 8(1) | 62(2) |
| 22 | 116 | 203 | 41 | 0.010 | 26(20) | 345(3) | 330(3) | 8(1) | 51(11) |
| 23 | 116 | 203 | 41 | 0.051 | 28(7) | 345(3) | 333(3) | 8(1) | 35(4) |
| 24 | 116 | 254 | 27 | 0.010 | 28(0) | 345(3) | 343(3) | 8(1) | 17.0(0.4) |
| 25 | 116 | 254 | 27 | 0.051 | 13(11) | 345(3) | 351(3) | 8(1) | 15.8(1) |
| 26 | 132 | 178 | 56 | 0.051 | 44(10),two values>50 | 345(3) | 320(2) | 8(1) | 54(7) |
| 27 | 132 | 178 | 56 | 0.102 | 26(21),one value>50 | 345(3) | 325(3) | 8(1) | 62(4) |
| 28 | 132 | 203 | 41 | 0.051 | 42(5) | 345(3) | 333(3) | 8(1) | 37(3) |
| 29 | 132 | 254 | 27 | 0.051 | 30(11) | 345(3) | 345(3) | 8(1) | 17(1) |
| 30 | 132 | 305 | 12 | 0.051 | 13(3) | 345(5) | 345(5) | 8(1) | 14(1) |
| 31 | 149 | 127 | 60 | 0.051 | 36(8) | 312(3) | 297(3) | 12(2) | 92(26) |
| 32 | 149 | 127 | 60 | 0.102 | 28(20), one value>50 | 312(3) | 290(3) | 12(2) | 151(56) |
| 33 | 149 | 178 | 44 | 0.051 | 50(0), two values>50 | 312(3) | 305(3) | 12(2) | 55(15) |
| 34 | 149 | 178 | 44 | 0.102 | 15(10) | 312(3) | 305(3) | 12(2) | 53(20) |
| 35 | 149 | 229 | 28 | 0.051 | 41(15),two values>50 | 312(8) | 318(8) | 12(2) | 29(6) |

Various modifications and alterations of this invention will become apparent to those skilled in the art without departing from the scope and principles of this invention, and it should be understood that this invention is not to be unduly limited to the illustrative embodiments set forth hereinabove. All publications and patents are herein incorporated by reference to the same extent as if each individual publication or patent was specifically and individually indicated to be incorporated by reference.

We claim:

1. A method of making a gas diffusion layer for an electrochemical cell comprising the steps of:
a) providing a plain-weave carbon fiber cloth;
b) coating a surface of said plain-weave carbon fiber cloth with a layer comprising carbon particles and one or more highly fluorinated polymers to make a coated plain-weave carbon fiber cloth; and
c) compressing said coated plain-weave carbon fiber cloth to a compression of 25% or greater; wherein said step of compressing does not include attaching said plain-weave carbon fiber cloth to another layer.

2. The method according to claim 1 wherein said step of compressing said coated plain-weave carbon fiber cloth comprises compressing said coated plain-weave carbon fiber cloth to a compression of 28% or greater.

3. The method according to claim 1 wherein said step of compressing said coated plain-weave carbon fiber cloth comprises compressing said coated plain-weave carbon fiber cloth to a compression of 40% or greater.

4. A gas diffusion layer for an electrochemical cell made according to the method of claim 1.

5. A gas diffusion layer for an electrochemical cell made according to the method of claim 3.

6. A membrane electrode assembly (MEA) comprising a gas diffusion layer made according to the method of claim 1 and a polymer electrolyte membrane (PEM) having a thickness of 50 microns or less.

7. A membrane electrode assembly (MEA) comprising a gas diffusion layer made according to the method of claim 3 and a polymer electrolyte membrane (PEM) having a thickness of 50 microns or less.

8. A membrane electrode assembly (MEA) comprising a gas diffusion layer made according to the method of claim 1 and a polymer electrolyte membrane (PEM) having a thickness of 35 microns or less.

9. A membrane electrode assembly (MEA) comprising a gas diffusion layer made according to the method of claim 3 and a polymer electrolyte membrane (PEM) having a thickness of 35 microns or less.

10. A membrane electrode assembly (MEA) according to claim 7 having an electrical area resistance of 400 ohm*cm² or greater when compressed to 25% compression.

11. A membrane electrode assembly (MEA) according to claim 7 having an electrical area resistance of 400 ohm*cm² or greater when compressed to 40% compression.

12. A membrane electrode assembly (MEA) according to claim 9 having an electrical area resistance of 400 ohm*cm² or greater when compressed to 25% compression.

13. A membrane electrode assembly (MEA) according to claim 9 having an electrical area resistance of 400 ohm*cm² or greater when compressed to 40% compression.

14. A membrane electrode assembly (MEA) comprising a g as diffusion layer that comprises a plain-weave carbon fiber cloth and comprising a polymer electrolyte membrane (PEM) having a thickness of 50 microns or less, wherein said membrane electrode assembly (MEA) has an electrical area resistance of 400 ohm*cm² or greater when compressed to 25% compression.

15. The membrane electrode assembly (MEA) according to claim 14 having an electrical area resistance of 400 ohm*cm² or greater when compressed to 40% compression.

16. The membrane electrode assembly (MEA) according to claim 14 comprising a polymer electrolyte membrane (PEM) having a thickness of 35 microns or less.

17. The membrane electrode assembly (MEA) according to claim 15 comprising a polymer electrolyte membrane (PEM) having a thickness of 35 microns or less.
